(19) United States
(12) Patent Application Publication
(10) Pub. No.: US 2011/0063257 A1
(43) Pub. Date: Mar. 17, 2011

(54) OPTICAL MEMBER FOR A TOUCH PANEL, AND MANUFACTURING METHOD FOR THE SAME

(76) Inventors: Takeshi Nojiri, Ibaraki (JP); Takeshi Yoshida, Ibaraki (JP); Ikuo Mukai, Ibaraki (JP); Keiko Funyu, Ibaraki (JP)

(21) Appl. No.: 12/922,233

(22) PCT Filed: Mar. 13, 2009
(86) PCT No.: PCT/JP2009/054884

§ 371 Date: Nov. 19, 2010

(30) Foreign Application Priority Data
Mar. 14, 2008 (JP) 2008-066308

(51) Int. Cl. G06F 3/042; B32B 37/24

(52) U.S. Cl. 345/175; 156/245

(57) ABSTRACT

An optical member 1 for a touch panel having a pair of opposite main surfaces S1 and S2. The optical member 1 includes a first layer 11 and a second layer 12 laminated over the first layer 11. The surface 11a of the first layer 11, adjacent to the second layer 12, has an irregular shape, and the surface 11a of the first layer 11 and the surface 12a of the second layer 12 are partially or completely separated from each other. When the optical member is pressed from one main surface S2, the surface of at least one of the first layer 11 and/or the second layer 12 is reversibly deformed, thereby changing the reflection state of reflected light L2, which is incident from the other main surface S1.

### TECHNICAL FIELD

The present invention relates to an optical member for a touch panel and a manufacturing method for the same.

### BACKGROUND ART

Due to the multifunctionalization of display devices, input devices represented by a touch panel have been widely used in recent days. The touch panel is an input device that can detect a position touched by a finger, a pen, or the like and, in most cases, has a function as a display device. Uses of the touch panel may include, for example, a mobile device, such as a mobile phone or a Portable Digital Assistant (PDA), an Automatic Teller Machine (ATM) used in a bank, or the like.

As methods of detecting a position where the touch panel is touched, for example, a resistive film type, a capacitance type, and an optical sensor type are known.

The resistive film type touch panel is generally configured such that a transparent conductive film is formed over the surface of a glass substrate, which is arranged over a screen of a display device, a fine spacer is arranged over the transparent conductive film, and a film having a transparent conductive film is attached over the fine spacer. When the film surface is not touched, the transparent conductive films are kept out of contact with each other by the spacer. When the film surface is touched, the film is bent so that the transparent conductive films come into contact with each other, thereby causing an electrical connection. Based on the change in the resistance of the electrically-connected portion, the touched position is detected. According to the characteristics of the resistive film type, input can be enabled by a finger or a pen and manufacturing costs can be reduced. However, since the transparent conductive film is soft, its endurance is not good. Repeated bending in response to touching causes deterioration, such as peeling or the like. This, for example, lowers the detection sensitivity, damages resolution, and lowers transmittance. In addition, there is also a general problem of low transmittance or the like (Patent Documents 1 and 2).

The capacitance type touch panel has a structure including one layer of transparent conductive film that detects electrical capacitance. It is possible to detect a touched position by detecting variations in a capacitance-coupled electrical signal from a touched portion. The capacitance type has better endurance and transmittance than the resistive film type. However, capacitance type has problems in that it is possible to operate the touch panel using only a finger or a specialized pen having conductivity, but input using a gloved finger or a nonconductive pen is impossible (Patent Document 1).

The optical sensor type includes an optical sensor, which has a function of detecting light, on a display device. The optical sensor detects a touch based on a change in the amount of received light. If the display device is a Liquid Crystal Display (LCD), the optical sensor is disposed, for example, in an indoor place. When a finger is placed on the touch panel, the finger shields external light incident on the optical sensor, thereby reducing the amount of light that the optical sensor receives. The touched position is detected based on this change (Patent Document 3). According to the optical sensor type, since an optical sensor can be arranged in each pixel of the display device, it is possible to use the display device as an image sensor. Therefore, the optical sensor type can advantageously provide a function as an image scanner. In addition, the optical sensor type can be expected to be used in a variety of applications, since it can afford multi-point input that is difficult to provide using the resistive film type or the capacitance type. In the optical sensor type, a method of using a light pen, which has a light source, as an input means has also been proposed.

In addition, in the case of the display device such as an LCD, a method of using reflected backlight as a light source, which the optical sensor detects, has also been proposed. In this method, the position of a touched portion is recognized when light from a backlight is reflected from the interface between the finger, which is placed on the screen, and the surface of the touch panel and then the optical sensor detects the reflected light.

[Patent document 1] Japanese Unexamined Patent Application Publication (Translation of PCT Application) No. 2005-530996
[Patent document 2] Japanese Unexamined Patent Application Publication (Translation of PCT Application) No. 2007-522586
[Patent document 3] Japanese Unexamined Patent Application Publication No. SHO 61-3232
[Patent document 4] Japanese Unexamined Patent Application Publication No. HEI 02-211421
[Patent document 5] Japanese Unexamined Patent Application Publication No. HEI 04-222918

### DISCLOSURE OF THE INVENTION

### Problems to be Solved by the Invention

As described above, the optical sensor type touch panel has many advantages such as endurance and multi-point input.

However, the optical sensor type touch panel has the following problem. In an environment in which the amount of received external light is insufficient, for example, a dimly-lit environment, even if a finger is placed on the touch panel, it is difficult to detect a change in the amount of received light, and thus the optical sensor is prone to errors in the detection of position. Although it is possible to solve this problem using a light pen, it is not convenient because a special light pen is necessary for the input. As a solution to insufficient external light, the method of using the reflection of light, generated from a backlight, is considered to be effective up to a point. However, when the LCD displays the color black, this method cannot reflect light from the backlight even if a finger is placed on the touch panel and thus cannot detect the position of the touched location.

The present invention has been made in view of the above-described circumstances, and the object of the invention is to provide an optical member that makes it possible to produce a touch panel, which can reduce errors even in environments having weak external light, enable input without using a special pen, and enable input even when an image on an LCD is displayed as the color black.

### Means for Solving the Problems

In an aspect of the invention, provided is an optical member for a touch panel having a pair of opposite main surfaces. When the optical member is pressed from one of the main surfaces, the optical member changes the reflection state of light, which is incident from the other one of the main surfaces.

When a certain position of the optical member according to an exemplary embodiment of the invention is pressed from one of the main surfaces, the reflection state of light, which is incident from the other one of the main surfaces, is changed. It is possible to recognize the pressed position by detecting a change in the reflected light using an optical sensor. In this method, errors rarely occur even if environments have weak external light, since light, generated from the display device, is used. In addition, a special input means such as a light pen or a conductive pen is not required. Furthermore, the optical member is provided inside a polarizer plate with respect to an LCD, since light reflected from the optical member itself is used. Accordingly, it is possible to effectively use light, generated from a backlight, and its reflection light even in a black displaying state.

More specifically, the optical member for a touch panel having a pair of opposite main surfaces may include a first layer and a second layer laminated over the first layer. The surface of the first layer, adjacent to the second layer, has an irregular shape, and the surface of the first layer and the surface of the second layer are partially or completely separated from each other. When the optical member is pressed from one of the main surfaces, the surface of the first layer and/or the second layer is reversibly deformed, thereby changing the reflection state of light, which is incident from the other one of the main surfaces.

Since the surface of the first layer and the surface of the second layer are partially or completely separated from each other, light, which has entered the optical member, is efficiently reflected from these surfaces. In addition, when the optical member is pressed from one of the main surfaces, the state of light, reflected from the surface of the first layer and/or the surface of the second layer, is changed according to the deformation of the surface of the first layer and/or the surface of the second layer. When a touch panel is configured using this optical member, as described above, it is possible to provide a touch panel, which can reduce errors even in environments having weak external light, enable input without using a special pen, and enable input even when an image on an LCD is displayed as the color black. In addition, the term “reversibly deforming” indicates a state in which deformation due to the application of mechanical pressure and restoration due to the release of mechanical pressure are reversible to each other, that is, elastic deformation is performed.

It is preferred that the first layer and/or the second layer have rubber elasticity. Due to this, the surfaces can be more easily reversibly deformed even when the optical member is pressed by a weak force. This makes it possible to recognize a position with higher sensitivity and precision. In addition, resistance against repeated use is further improved.

It is preferred that the irregular shape of the surface of the first layer has a maximum height of from 0.01 to 50 μm. Due to this, the effects of the invention are more significantly realized.

An intermediate layer can be provided between the first layer and the second layer, the intermediate layer having a refractive index different from that of the first layer. Due to this, it is possible to produce a touch panel that has excellent resistance against changes in the environment, such as temperature or air pressure, compared to a state where a cavity is formed without the intermediate layer between the first layer and the second layer. It is preferred that the intermediate layer be laminating.

The optical member according to an exemplary embodiment of the invention can be stored, for example, in the form of a laminated body that includes a backing film and an optical member provided over the backing film. The use of the laminated body can contribute to lower costs, since the optical member can be treated with good workability.

In another aspect of the invention, provided is a manufacturing method for the above-described optical member. The manufacturing method according to an exemplary embodiment of the invention includes a process of forming a first layer on an irregular surface of a mold, the first layer having a surface that has an irregular shape transferred from the irregular surface; a process of peeling the first layer from the mold; and a process of laminating a second layer over the surface of the peeled first layer, which has the irregular shape. Due to this manufacturing method, it is possible to efficiently manufacture with good workability the optical member according to an exemplary embodiment of the invention.

### EFFECT OF THE INVENTION

According to exemplary embodiments of the invention, it is possible to provide a touch panel, which can reduce errors even in environments having weak external light, enable input without using a special pen, and enable input even when an image on an LCD is displayed as the color black.

### BRIEF DESCRIPTION OF THE DRAWINGS

FIG. 1 is an end view showing an exemplary embodiment of a touch panel that has an optical member mounted thereon.

FIG. 2 is an end view explaining a function of an optical member.

FIG. 3 is an end view explaining a function of an optical member.

FIG. 4 is an end view showing an exemplary embodiment of a manufacturing method for an optical member.

### EXPLANATION OF SYMBOLS

1: optical member, 2: cavity, 4: liquid crystal cell, 11: first layer, 12: second layer, 20, 21: polarizer plate, 22: phase difference plate, 23: glass substrate, 24: glass substrate, 25: color filter, 30, 31: adhesion layer, 40, 41: transparent electrode, 42, 43: alignment film, 45: liquid crystal layer, 47: spacer, 50: light-shielding film, 51: thin film transistor, 52: optical sensor, 54: insulating film, 60: backlight, 100: touch panel, S1, S2: main surface of optical member, S100: screen.

### BEST MODES FOR CARRYING OUT THE INVENTION

Hereinafter, exemplary embodiments of the present invention will now be described in detail. However, the present invention is not limited to the following embodiments.

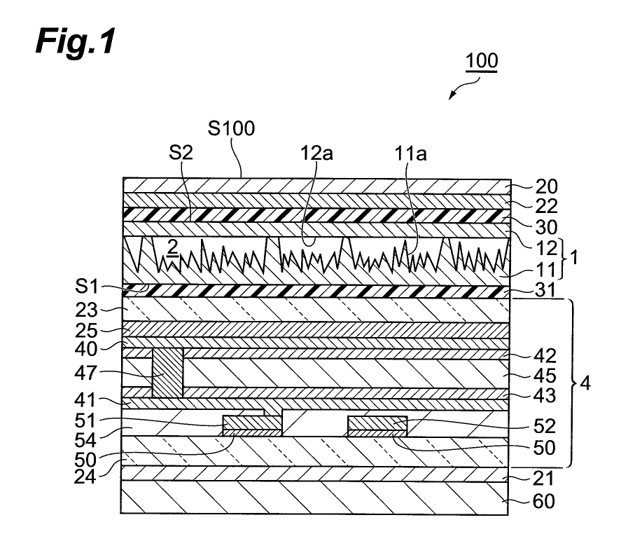

FIG. 1 is an end view showing an embodiment of a touch panel that has an optical member. A touch panel 100 shown in FIG. 1 generally includes a liquid crystal cell 4, a backlight 60 provided on one side of the liquid crystal cell 4 to serve as a light source, an optical member 1 provided on the other side of the liquid crystal cell 4, an optical sensor 52 provided inside the liquid crystal cell 4, and a pair of polarizer plates 20 and 21 arranged opposite each other, with the liquid crystal cell 4 and the optical member 1 interposed therebetween.

The liquid crystal cell 4 includes two sheets of glass substrate 23 and 24, which are arranged opposite each other, a thin film transistor (TFT) 51 and the optical sensor 52, which are provided on the glass substrate 24 adjacent to the backlight 60, an insulating film 54, which covers the TFT 51 and the optical sensor 52, and a transparent electrode 41, which is laminated over the insulating film 54, an alignment film 43, a liquid crystal layer 45, an alignment film 42, and a transparent electrode 40. Light-shielding films 50 are provided between the glass substrate 24 and the TFT 51 and between the glass substrate 24 and the optical sensor 52. A spacer 47 is provided between the alignment film 42 and the alignment film 43. An adhesion layer 31, the optical member 1, an adhesion layer 30, a phase difference plate 22, and the polarizer plate 20 are laminated sequentially over the glass substrate 23.

The touch panel 100 shown in FIG. 1 is an input device that has a function as a liquid crystal display (LCD) device as well as a function to detect a certain position on a screen S100 when the position is touched by a finger or the like.

The optical member 1 includes a first layer 11 and a second layer 12 laminated over the first layer 11. The optical member 1 is a laminated sheet that has a main surface S1 adjacent to the first layer 11 and a main surface S2 adjacent to the second layer. The surface 11a of the first layer 11, which is adjacent to the second layer 12, has an irregular shape, and the surface 12a of the second layer 12, which is adjacent to the first layer 11, is flat. The optical member 1 is arranged in a direction such that the first layer 11 is located toward the backlight 60 and the optical sensor 52.

The surface 11a of the first layer and the surface 12a of the second layer are partially separated from each other, thereby forming cavities 2 between the first layer 11 and the second layer 12. The gas inside the cavities 2 can be air, or any type of stable and harmless gas, such as nitrogen, helium, or argon. As an alternative, the inside of the cavities 2 can be a vacuum.

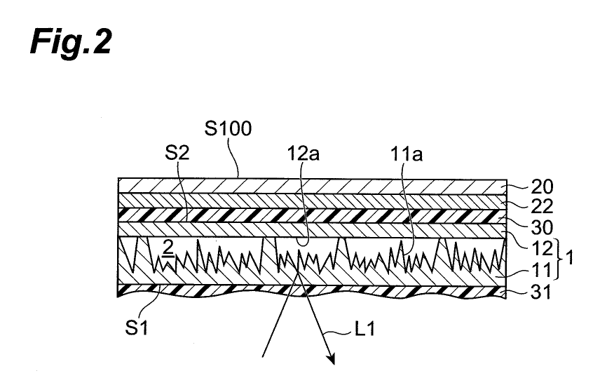

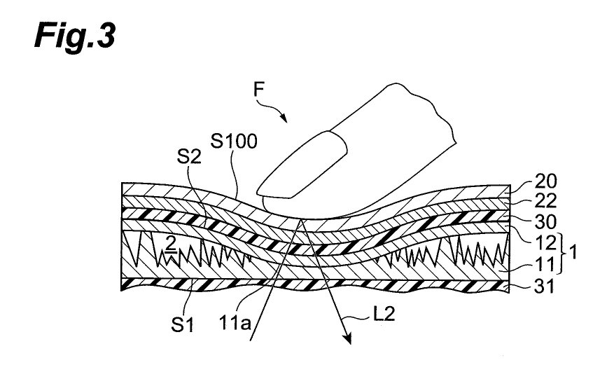

FIGS. 2 and 3 are schematic views explaining the function of the optical member 1. As shown in FIG. 2, when the screen S100 of the touch panel 100 is not pressed, some of the light, which has been generated from the backlight 60 and has subsequently entered the optical member 11, is reflected from the surface 11a of the first layer 11, thereby forming reflected light L1. Since the surface 11a has an irregular shape, light is easily reflected or scattered on the surface 11a, and the optical sensor 52, provided adjacent to the first main surface S1, receives a relatively large amount of light, which includes scattered light.

As shown in FIG. 3, when a certain position of the screen S100 of the touch panel 100 is touched by a finger F, the optical member 1 is pressed from the main surface S2. The second layer 12, to which mechanical pressure is locally applied like this, is deformed toward the first layer 11, so that the first layer 11 and the second layer 12 are pressed against each other. Then, protrusions in the irregular shape of the surface 11a are pressed through contact with the surface 12a, thereby reversibly deforming the surface 11a. As a result, the pressed position of the first layer surface 11a is converted into a substantially flat shape, corresponding to the surface 12a. If the surface 11a is flat, the amount of light reflected or scattered therefrom decreases, so that light, which has entered the optical member 1, is mainly reflected from the interface between the finger F and the screen S100. The amount of reflected light L2, reflected from the interface between the finger F and the screen S100, is generally smaller than that of reflected light L1. In addition, the amount or luminance of light, which passes through the optical member, is increased. The amount of light, which is received by the optical sensor 52 in this state, is often smaller than that when the optical member 1 is not pressed.

As such, when the optical member 1 is pressed from the main surface S2, the amount of light incident or the like from the main surface S1 is changed. Detection of the optical change using the optical sensor, provided adjacent to the main surface S1, makes it possible to determine the certain position of the touch panel 100, which is touched. In addition, since the optical member 1 is provided between the polarizer plate 20, adjacent to the screen S100, and the backlight 60, even in a black displaying state it is possible to use the backlight and light reflected therefrom as efficiently as in a white displaying state or the like.

Examples of the optical sensor 52 are not specifically limited as long as they can detect optical parameters of reflected light, such as the amount of light. Specific examples may include, for example, a semiconductor device made of amorphous silicon and a semiconductor device made of polysilicon, which can produce a photoelectric effect.

The first layer 11 of the optical member 1 has rubber elasticity that is able to reversibly deform in response to mechanical pressure. Due to the rubber elasticity of the first layer 11, the surface 11a thereof can easily be reversibly deformed when the optical member 1 is pressed. From the point of view of the endurance of the touch panel, it is preferred that at least one of the first layer and the second layer have rubber elasticity.

From the point of view of the endurance, operability, error prevention, or the like of the touch panel, it is preferred that the compression elasticity of the first layer 11 be from 0.01 to 100 MPa. If the compression elasticity is less than 0.01 MPa, the surface is deformed even if mechanical pressure is not applied, so that light incident from the light source is not easily reflected or scattered. If the compression elasticity is greater than 100 MPa, the surface 11a is not easily deformed when pressed by a small amount of pressure. Therefore, it tends to be difficult to convert a mechanical pressure change into an optical change. From the same point of view, it is preferred that the compression elasticity be from 0.01 to 100 MPa, from 0.05 to 90 MPa, from 0.1 to 80 MPa, from 0.5 to 70 MPa, from 1 to 60 MPa, or from 1 to 10 MPa.

The compression elasticity can be obtained from the inclination of a load-deformation curve, which is measured in a compression test using an ultrafine hardness meter under the following conditions.

Thickness of sample film: 100 μm (compressed in direction of thickness)

Temperature: 25° C.

Maximum pressure applied: 0.1 mN/μm²

Measuring time: 20 seconds

Depressor: circular flat depressor (diameter: φ50 μm)

The irregular shape of the surface 11a of the first layer 11 can have any shape as long as it can reflect or scatter part of incident light. It is preferred that the maximum height of the irregular shape (i.e., the maximum value of the difference between the height of the top of the protrusions and the depth of the bottom of depressions in a cross section having a certain length (e.g., 10 mm)) be from 0.01 to 50 μm. This makes it possible to efficiently reflect, in particular, light incident from the backlight 60, thereby effectively detecting light using the optical sensor 52. In addition, it is possible to more sensitively detect the touched position of the touch panel 100. From the same point of view, it is preferred that the maximum height of the irregular shape be from 0.1 to 45 μm, from 0.5 to 40 μm, from 0.7 to 35 μm, or from 1 to 30 μm. In addition, from the same point of view, it is preferred that the distance between two adjacent depressions be from 0.01 to 150 μm, from 0.1 to 100 μm, from 0.5 to 90 μm, from 0.7 to 70 μm, or from 1 to 50 μm.

From the point of view that it is possible to efficiently detect an optical change converted from a change in mechanical pressure due to pressing while maintaining good display quality, the first layer 11 and the second layer 12 are preferably made of a high-transparency material. Specifically, it is preferred that the visible light transmittance of a film in which both surfaces are flat with a thickness of 20 μm and that was made of the same material as the first layer 11 or the second layer 12, be from 70 to 100%, from 75 to 98%, from 80 to 97%, from 83 to 96%, or from 85 to 95%. The visible light transmittance can be measured by the same method that measures a change in visible light transmittance before and after pressing using the film in which both surfaces are flat and that was made of the same material as the first layer 11 or the second layer 12. The measuring method will be described later.

From the point of view that effectively realizes a change in the amount of light before and after a deformation in the surface 11a, it is preferred that the absolute value of the difference between the refractive index of the first layer 11 and the refractive index of the second layer 12 be from 0 to 0.1. From the same point of view, when the cavities 2 are formed between the first layer 11 and the second layer 12, it is preferred that the refractive index of the first layer 11 and the second layer 12 be 1.3 or more. The refractive index is measured by a known method, such as a prism coupling method, a spectrum ellipsometry method, or the like.

The material that forms the first layer 11, which has rubber elasticity, is preferably a variety of elastomer. Specific examples of the proper elastomer may include a natural rubber, synthetic polyisoprene, a copolymer of styrene and butadiene, a copolymer of butadiene and acrylonitrile, a copolymer of butadiene and alkyl acrylate, butyl rubber, bromobutyl rubber, chlorobutyl rubber, neoprene (chloroprene, 2-chloro-1,3-butadiene), an olefin-based rubber (e.g., ethylene propylene rubber (EPR) and ethylene propylene diene monomer (EPDM) rubber), a nitrile elastomer, a polyacrylic elastomer, a polysulfide polymer, a silicone elastomer, a thermoplastic elastomer, a thermoplastic copolyester, an ethylene acrylic elastomer, a vinyl acetate ethylene copolymer, epichlorohydrin, chlorinated polyethylene, chemically-linked polyethylene, chlorosulfonated polyethylene, fluorocarbon rubber, and fluorosilicone rubber. These examples can be used separetly, or two or more examples can be used in combination. From among the specific materials having the rubber elasticity, a silicone elastomer is especially preferable from the point of view that the above-described irregular shape has excellent formability.

Silicone elastomers include, for example, peroxide-cross-linked silicone rubber, additional reactive silicone rubber, photoreactive silicone rubber, and photoradical polymerized silicone rubber. The peroxide-cross-linked silicone rubber can be produced by a method that forms a rubber elastic body by cross-linking silicon crude rubber made of straight-chained polymer polyorganosiloxane by mixing organic peroxide into silicone crude rubber and heating the mixture. The addition reaction silicone rubber can be produced by a method that forms a rubber elastic body by performing cross-linking through addition reaction between polyorganosiloxane having an aliphatic unsaturated hydrocarbon group and polyorganohydrogensiloxane in the presence of platinum catalyst. The photoreactive silicone rubber can be produced by a method that forms a rubber elastic body by cross-linking epoxy group-containing polyorganosiloxane through light emission, in the presence of photoacid generator. The photoradical polymerized silicone rubber can be produced by a method that forms a rubber elastic body by cross-linking acryloyl group-containing polyorganosiloxane through light emission, in the presence of photoinitiator.

Polyorganosiloxane, which is used for forming additional reactive silicone rubber, has two or more monovalent aliphatic unsaturated hydrocarbon groups, which are bonded to a silicon atom, in one molecule. Examples of the monovalent aliphatic unsaturated hydrocarbon groups include vinyl group, allyl group, 1-butenyl group, and 1-hexenyl group. The vinyl group is most preferable since it is easy to synthesize. In addition, a composition before curing has excellent fluidity or a composition after curing has excellent heat resistance. Furthermore, the monovalent aliphatic unsaturated hydrocarbon group may be present in any one or both of a terminal or an intermediate portion of a polyorganosiloxane molecule chain. However, in order to provide excellent mechanical properties to a composition after cross-linking, it is preferred that polyorganosiloxane have monovalent aliphatic unsaturated hydrocarbon groups on at least both terminals of a molecular chain.

In addition, examples of other organic groups, which are bonded to a silicon atom of polyorganosiloxane, may include an alkyl group, such as methyl, ethyl, propyl, butyl, pentyl, hexyl, octyl, decyl, and dodecyl, an aryl group, such as phenyl, an aralkyl group, such as benzyl, 2-phenyl ethyl, and 2-phenyl propyl, a substituted hydrocarbon group, such as chloromethyl, chlorophenyl, 2-cyanoethyl, and 3,3,3-trifluoropropyl. The methyl group is most preferable since it is easy to synthesize and has excellent balance in characteristics, such as fluidity before cross-linking or compression elasticity of a formed rubber elastic body.

Polyorganosiloxane can be straight-chained or branched. In addition, while polyorganosiloxane does not have a specifically-limited degree of polymerization, the viscosity at 25° C. is, preferably, from 500 to 500000 MPa·s and, particularly preferably, from 1000 to 100000 MPa·s, so that the composition before the cross-linking has good fluidity and workability and the composition after the cross-linking has a suitable compressive elasticity.

Polyorganohydrogensiloxane, which is used for forming additional reactive silicone rubber, functions as a cross-linker of polyorganosiloxane, since a hydrosilyl group contained in the molecule is added to monovalent aliphatic unsaturated hydrocarbon group in polyorganosiloxane. In order to efficiently form a mesh-like structure, it is preferred that polyorganohydrogensiloxane have three or more hydrogen atoms bonded to a silicon atom. In addition, examples of other organic groups, which are bonded to a silicon atom of a polyorganosiloxane unit, may include organic groups, except for the above-described monovalent aliphatic unsaturated hydrocarbon group in polyorganosiloxane, and their equivalents. From among these groups, the methyl group is most preferable since it is easy to synthesize. In addition, the siloxane structure in polyorganohydrogensiloxane can be any one of straight-chained, branched, and annular configurations, or a mixture thereof. While polyorganohydrogensiloxane does not have specifically-limited degree of polymerization, it is preferred that polyorganohydrogensiloxane has three or more siloxane units since it is difficult to synthesize polyorganohydrogensiloxane having two or more hydrogen atoms bonded to the same silicon atoms.

The amount of polyorganohydrogensiloxane to be mixed is preferably in such a range that the number of hydrogen atoms bonded to a silicon atom in polyorganohydrogensiloxane for one monovalent aliphatic unsaturated hydrocarbon group in polyorganosiloxane is from 0.5 to 5 and, preferably, from 1 to 3. If the ratio of hydrogen atoms present is less than 0.5, cross-linking becomes easily unstable. If the ratio of hydrogen atoms present is greater than 5, bubbles are easily formed during cross-linking and surface conditions tend to degrade.

It is preferred that the additional reactive silicone rubber uses a platinum-based compound as a catalyst for promoting addition reaction between the monovalent aliphatic unsaturated hydrocarbon group of polyorganosiloxane and the hydrosilyl group of polyorganohydrogensiloxane. Examples of the platinum-based compound include platinum acid chloride, a reactant of platinum acid chloride and alcohol, a platinum-olefin complex, a platinum-vinyl siloxane complex, and a platinum-phosphine complex. The reactant of platinum acid chloride and alcohol and the platinum-vinyl siloxane complex are preferable in consideration that solubility in respect to polyorganosiloxane and polyorganohydrogensiloxane, as well as catalytic activity, are good. The amount of the platinum-based compound mixed is, preferably, from 1 to 200 ppm by weight or, more preferably, from 1 to 100 ppm by weight or, even more preferably, from 2 to 50 ppm by weight when converted into platinum atoms with respect to polyorganosiloxane. If the amount is less than 1 ppm by weight, the curing rate is insufficient, thereby tending to lower the manufacturing efficiency of the optical member. If the amount is greater than 200 ppm by weight, the cross-linking rate is excessively accelerated, thereby tending to damage workability after individual components are mixed.

The second layer 12 is preferably made of a hard material that has substantially no rubber elasticity in consideration that the irregular shape of the first layer 11 can be effectively deformed by mechanical pressure. Specifically, the second layer 12 is preferably made of an inorganic material selected from glass and ceramics, or an organic material selected from triacetyl cellulose, polyethersulphone, polyethylene terephthalate, and polyether naphthalate.

The difference in visible light transmittance between when the optical member 1 is not pressed and when the optical member 1 is pressed (i.e., a change in visible light transmittance before and after pressing) is preferably from 0.1 to 50%. If the difference is less than 0.1%, it tends to be difficult to detect an optical change due to the addition of mechanical pressure using the optical sensor. If the difference is greater than 50%, it is necessary to strengthen reflection or scattering at the first layer 11 or the second layer 12 when mechanical pressure is not added. This, however, tends to make it difficult to design the irregular shape while also degrading display quality as a display device. From the same point of view, it is preferred that the change in visible light transmittance before and after pressing be from 0.5 to 45%, from 1 to 40%, from 2 to 35%, or from 3 to 30%.

The change in visible light transmittance before and after pressing can be measured in the following sequence of steps 1) to 7). In addition, visible light refers to a ray of light, which has a visible wavelength range from 380 to 780 nm and is generally visible.

1) A sample is prepared by placing an optical member over a glass substrate and placing a disc-like glass plate, which has a diameter of φ10 mm and a thickness of 0.7 mm, over the optical member.

2) A ray of light in the visible range corresponding to the sample is emitted onto the sample in a # normal line direction. The luminance a of light, which has passed through the sample in the range of a measurement view angle of 1°, is measured using a luminance colorimeter. In this state, the optical member is removed and luminance b is measured in the same fashion.

3) Visible light transmittance T1 when the optical member is not pressed is calculated by the formula: T1=(a/b)×100(%).

4) A sample having the same specification as above is prepared, and a load of 5×10³ Pa is applied to between the glass substrate and the disc-like glass plate.

5) While the load is being applied to the sample, a ray of light in the visible range is emitted onto the sample in a normal line direction. The luminance c of light, which has passed through the sample in the range of a measurement view angle of 1°, is measured using a luminance colorimeter. In this state, the optical member is removed and luminance d is measured in the same fashion.

6) Visible light transmittance T2 when the optical member is pressed is calculated by the formula: T2=(c/d)×100(%).

7) The absolute value of the difference ΔT between the visible light transmittance T1 and the visible light transmittance T2 is sought as a change in the visible light transmittance before and after pressing.

It is preferred that the difference in reflectivity of visible light between when the optical member 1 is not pressed and when the optical member 1 is pressed (i.e., the change in visible light reflectivity before and after pressing) be from 0.1 to 50%. If the difference is less than 0.1%, it tends to become difficult to detect an optical change due to the addition of mechanical pressure using the optical sensor. If the difference is greater than 50%, it is necessary to strengthen reflection or scattering at the first layer 11 or the second layer 12 when mechanical pressure is not added. This, however, tends to make it difficult to design the irregular shape while degrading display quality as a display device. From the same point of view, it is preferred that the change in visible light transmittance before and after pressing be from 0.5 to 48%, from 1 to 45%, from 2 to 43%, or from 3 to 40%.

The change in visible light reflectivity before and after pressing can be measured in the following sequence.

1) A glass substrate, which has a thickness of 0.7 mm, and a disc-like glass substrate, which has a diameter of φ10 mm and a thickness of 0.7 mm, are placed over a white plate made of magnesium oxide or the like. A ray of light in the visible range is emitted onto the white plate in a normal line direction. The brightness a′ of the ray of light, which has been reflected at an angle 25° with respect to the normal line direction of the white plate, is measured using a spectrum color meter or the like. An optical member is placed between the glass substrate and the disc-like glass plate, and the brightness b′ of the reflected light is measured in the same fashion as in 1).

2) Visible light reflectivity R1 when the optical member is not pressed is calculated by the formula: R1=(b′/a′)×100(%).

3) The brightness c′ of the reflected light is measured in the same fashion as in 1) while a load of 5×10³ Pa is being added between the glass substrate and the disc-like glass plate.

4) Visible light reflectivity R2 when the optical member is pressed is calculated by the formula: R2=(c′/a′)×100(%).

5) The absolute value of the difference ΔR between the visible light reflectivity R1 before pressing and the visible light reflectivity R2 after pressing is sought as a change in the visible light reflectivity before and after pressing.

The film thickness of the first layer 11 (i.e., the thickness of the portion of the first layer 11, except for the irregular shape in the direction of thickness) is preferably from 1 to 500 μm. If the film thickness of the first layer 11 is less than 1 μm, it becomes difficult to manufacture the first layer 11 having the irregular shape. If the film thickness of the first layer 11 is greater than 500 μm, the transmission of pressure when the pressure is added to the optical member is weakened, thereby tending to hinder the first surface 11 from changing the surface shape. From the same point of view, the film thickness of the first layer 11 is, preferably, from 5 to 400 μm or, more preferably, from 10 to 300 μm.

In the optical member 1, from the point of view of the display quality of the touch panel 100, it is preferred that the absolute value of the difference in transmittance between visible light, which is incident on one surface, and visible light, which is incident on the other surface, be from 1 to 20%. If the absolute value of the difference in transmittance is less than 1%, the touch panel is apt to reflect external light, thereby tending to degrade display quality. If the absolute value of the difference in transmittance is greater than 20%, the optical design of the irregular shape, which realizes this, becomes difficult. From the same point of view, it is preferred that the absolute value of the difference in transmittance be from 1.5 to 17%, from 2 to 15%, from 2.5 to 12%, or from 3 to 10%.

The transmittance of visible light can be produced by measuring visible light transmittances from both sides of the optical member 1 in the same way as in the measurement of “a change in visible light transmittance before and after pressing” and calculating the absolute value of the difference between the measured visible light transmittances.

An intermediate layer, which has a refractive index different from that of the first layer 11, can be provided between the first layer 11 and the second layer 12. With the intermediate layer provided, it is possible to produce a touch panel that has better endurance against changes in the use environment compared to the case where the cavities 2 are formed.

It is preferred that the absolute value Δn of the difference between the refractive index of the first layer 11, of which the surface 11a has the irregular shape, and the reflective index of the intermediate layer be from 0.01 to 1.0. If the absolute value of the difference between the refractive indexes is less than 0.01, the optical sensor cannot efficiently detect light reflected from the optical sensor 1 when the optical sensor is not pressed. Thereby, it tends to be difficult to properly recognize the touched position. In addition, if the absolute value of the difference between the refractive indexes is greater than 1.0, selection of a material that has a refractive index necessary for realizing it tends to be difficult. From the same point of view, it is preferred that the absolute value of the difference between the refractive indexes be from 0.03 to 0.7, from 0.05 to 0.5, from 0.07 to 0.3, or from 0.1 to 0.2. The refractive index is measured by a known method, such as a prism coupling method, a spectrum ellipsometry method, or the like.

It is preferred that the intermediate layer be laminating. Resins, which are used to form the laminating intermediate layer, are not specifically limited as long as they are laminating to the first layer or the second layer. Examples of the resins may include an acrylic resin, a cross-linked acrylic resin, an acrylic monomer, a silicone resin, a fluororesin, and a polyvinyl alcohol resin. These examples can be used separately, or two or more examples can be used in combination.

The acrylic resin is preferably a copolymer including an unsaturated monomer that has a low glass transition temperature. Examples of the unsaturated monomer that has a low glass transition temperature may include acrylic acid butyl, methacrylic acid butyl, acrylic acid ethyl, methacrylic acid ethyl, acrylic acid 2-ethyl hexyl, and methacrylic acid 2-ethyl hexyl. Other examples of unsaturated monomers, which are used in a copolymer including an unsaturated monomer that has a low glass transition temperature, may include acrylic acid methyl, methacrylic acid methyl, acrylic acid ethyl, methacrylic acid ethyl, acrylic acid n-propyl, methacrylic acid n-propyl, acrylic acid iso-propyl, methacrylic acid iso-propyl, acrylic acid n-butyl, methacrylic acid n-butyl, acrylic acid iso-butyl, methacrylic acid iso-butyl, acrylic acid sec-butyl, methacrylic acid sec-butyl, acrylic acid tert-butyl, methacrylic acid tert-butyl, acrylic acid pentyl, methacrylic acid pentyl, acrylic acid hexyl, methacrylic acid hexyl, acrylic acid heptyl, methacrylic acid heptyl, acrylic acid 2-ethyl hexyl, methacrylic acid 2-ethyl hexyl, acrylic acid octyl, methacrylic acid octyl, acrylic acid nonyl, methacrylic acid nonyl, acrylic acid decyl, methacrylic acid decyl, acrylic acid dodecyl, methacrylic acid dodecyl, acrylic acid tetra decyl, methacrylic acid tetra decyl, acrylic acid hexadecyl, methacrylic acid hexadecyl, acrylic acid octadecyl, methacrylic acid octadecyl, acrylic acid eicosyl, methacrylic acid eicosyl, acrylic acid docosyl, methacrylic acid docosyl, acrylic acid cyclopentyl, methacrylic acid cyclopentyl, acrylic acid cyclohexyl, methacrylic acid cyclohexyl, acrylic acid cycloheptyl, methacrylic acid cycloheptyl, acrylic acid benzyl, methacrylic acid benzyl, acrylic acid phenyl, methacrylic acid phenyl, acrylic acid methoxy ethyl, methacrylic acid methoxy ethyl, acrylic acid dimethyl aminoethyl, methacrylic acid dimethyl aminoethyl, acrylic acid diethyl aminoethyl, methacrylic acid diethyl aminoethyl, acrylic acid dimethyl aminopropyl, methacrylic acid dimethyl aminopropyl, acrylic acid 2-chloroethyl, methacrylic acid 2-chloroethyl, acrylic acid 2-fluoroethyl, methacrylic acid 2-fluoroethyl, styrene, α-methyl styrene, cyclohexyl maleimide, acrylic acid dicyclopentanyl, methacrylic acid dicyclopentanyl, vinyl toluene, vinyl chloride, vinyl acetate, N-vinyl pyrrolidone, butadiene, isoprene, and chloroprene. These examples can be used separately, or two or more examples can be used in combination.

The cross-linked acrylic resin is produced by cross-linking a copolymer, which includes an unsaturated monomer having a functional group as a copolymerization component, using a cross-linker. Examples of unsaturated monomers include acrylic acid, methacrylic acid, acrylic acid 2-hydroxy ethyl, methacrylic acid 2-hydroxy ethyl, acrylamide, and acrylonitrile.

Known cross-linkers, such as isocyanate-, melamine-, and epoxy-based cross-linkers, can be used as the cross-linker. In addition, multifunctional cross-linkers, such as trifunctional or quadrafunctional cross-linkers, are more preferably used as a cross-linker for forming a mesh-like structure that is smoothly spread in the cross-linked acrylic resin.

In the copolymer used for producing acrylic resin and cross-linked acrylic resin, the average molecular weight (i.e., the value that is measured using gel permeation chromatography and is standard polystyrene-converted) is, preferably, from 1000 to 300000 and, more preferably, from 5000 to 150000 from the point of view of adhesion to the first layer 11 or the second layer 12.

The laminating resin may include a monomer from the point of view that it efficiently deforms the surface shape of the first layer or the second layer by revealing high fluidity. Available examples of the monomer may include polyethylene glycol diacetate, polypropylene glycol diacetate, a urethane monomer, nonyl phenyl dio-xylene acrylate, nonyl phenyl dio-xylene methacrylate, γ-chloro-β-hydroxy propyl-β′-acryloyloxy ethyl-o-phthalate, γ-chloro-β-hydroxy propyl-β′-methacryloyloxy ethyl-o-phthalate, β-hydroxy ethyl-β′-acryloyloxy ethyl-o-phthalate, β-hydroxy ethyl-β′-methacryloyloxy ethyl-o-phthalate, β-hydroxy propyl-β′-acryloyloxy ethyl-o-phthalate, β-hydroxy propyl-β′-methacryloyloxy ethyl-o-phthalate, o-phenylphenol glycidyl ether acrylate, o-phenylphenol glycidyl ethermethacrylate, or an unsaturated monomer used in acrylic resin. These examples can be used independently, or two or more examples can be used in combination

It is preferred that the glass transition temperature (Tg) of the intermediate layer be −20° C. or less. If the glass transition temperature of the intermediate layer is higher than −20° C., adhesion is lowered, so that an appropriate amount of laminating force for the first layer 11 and the second layer 12 may not be obtained.

It is preferred that the thickness of the intermediate layer (i.e., the thickness of the portion except for those filled in recesses of the irregular shape) be from 1 to 50 μm. If the thickness of the intermediate layer is less than 1 μm, bubbles tend to be mixed in when the first layer or the second layer is laminated. If the thickness of the intermediate layer is greater than 50 μm, it becomes difficult to transfer pressure when the touch panel is touched. Thereby, it tends to be difficult to deform the surface shape of the first layer 11. From the same point of view, the thickness of the intermediate layer is, more preferably, from 2 to 40 μm or, even more preferably, from 3 to 30 μm.

The optical member 1 can be used in the form of a laminated body that has a backing film and the optical member 1 provided over the backing film. Examples of the backing film may include films having a thickness from 5 to 100 μm, which is made of polyethylene terephthalate, polycarbonate, polyethylene, polypropylene, polyethersulphone, or triacetyl cellulose.

A resin layer that is laminating or tacky may be provided between the backing film and the first layer 11, or between the backing film and the second layer 12.

Furthermore, a cover film can be laminated over the first layer 11 or the second layer 12. The cover film can be a film having an approximate thickness from 5 to 100 μm that is made of polyethylene, polypropylene, polyethylene terephthalate, polycarbonate, triacetyl cellulose, or the like. A resin layer that is laminating or tacky may be provided between the cover film and the first layer 11 or between the cover film and the second layer 12.

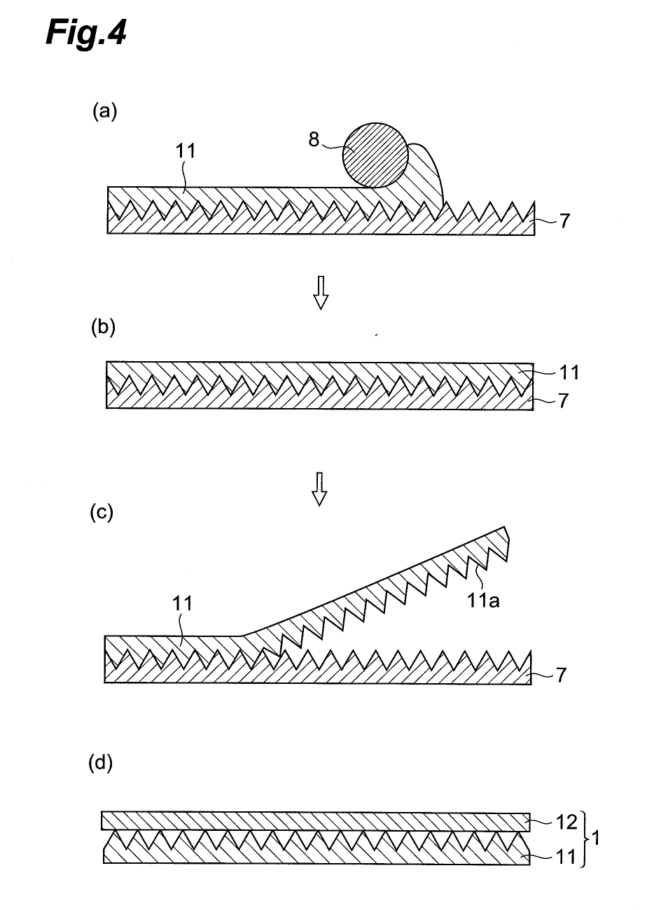

FIG. 4 is an end view showing an embodiment of a manufacturing method for the optical member 1. The manufacturing method shown in FIG. 4 includes a process of forming the first layer 11 on an irregular surface of a mold 7, the first layer 11 having the surface 11a that has the irregular shape transferred from the irregular surface, a process of peeling the first layer 11 from the mold 7, and a process of laminating the second layer 12 over the surface of the peeled first layer 11, which has the irregular shape.

As shown in FIG. 4 (a), a liquid, which includes the same component as the first layer 11, is applied over the irregular surface of the mold 7 using a roll 8. The applied liquid is transformed into a solid phase by heat, light, or the like (FIG. 4 (b)). Afterwards, the first layer 11 is peeled from the mold 7 (FIG. 4 (c)). As an alternative, it is possible to employ a method of applying the liquid 11, which is supposed to form the first layer, over the flat substrate, pressing a mold having an irregular surface against the liquid, and then converting the liquid in the pressed state into a solid state.

As another alternative, it is possible to produce the first layer 11 having an irregular shape on both surfaces by a method of laminating another mold having an irregular surface over the liquid 11 applied over the mold 7 and then converting the liquid in that state into a solid state.

The mold 7 is a film that has a number of depressions and protrusions in the surface thereof. The mold 7 can be produced by, for example, pressing a master mold having an irregular surface against a photo-sensitive resin composition layer, which is formed over a flat backing film, and photo-curing the photosensitive resin composition layer in that state. In addition, it is possible to produce the first layer by a method of directly pressing a flat surface of a film against a master mold having an irregular surface so that the irregular shape is transferred to the surface of the film. Otherwise, a method of performing sand blasting on a flat surface of a film is possible.

The master mold can be produced by, for example, a method of forming a resister pattern by performing development and exposure or laser cutting on a photoresist, which is applied over a glass plate, using a photomask having a certain mask pattern, forming a metal film of silver, nickel, or the like over the resister pattern by vapor deposition or sputtering (electroconductivity treatment), laminating a metal, such as copper, nickel, or the like, over the metal film by electroforming, and then peeling the metal film from the glass plate. In this case, the irregular shape of the master mold is transferred to the surface of the first layer 11, since it is possible to control the irregular pattern according to a random shape, a linear shape, a spherical shape, an angular shape, a columnar shape, a dot lens shape, a cylindrical lens shape, or the like by the shape of the mask pattern or the resister pattern.

It is also possible to manufacture a master mold having a number of depressions and protrusions on the surface thereof by plating a metal, such as copper or nickel, over the surface of a conductive metal. In this case, a random irregular shape is formed. It is also possible to manufacture a master mold by a method of pressing diamond depressors against a flat master-mold-forming substrate made of stainless steel or the like. Here, a number of irregular shapes, which have a partially flat surface, a spherical surface, or a curved surface, can be formed by pressing the diamond depressors while moving the master-mold-forming substrate in a horizontal direction, or by pressing the depressors while moving the depressors with the master-mold-forming substrate left stationary. It is possible to control a random shape, a linear shape, a rectangular shape, an angular shape, a columnar shape, a dot lens shape, a cylindrical lens shape, or the like by selecting the shape of the diamond depressors. In this case, the master mold can be a flat plate or a roll having a curved surface. In addition, the irregular shapes can be arranged randomly or according to a predetermined rule.

The method of applying the liquid 11, which is supposed to form the first layer 11, can employ a known application method. Examples may include a doctor blade coating method, a Meyer bar coating method, a roll coating method, a screen coating method, a spinner-coating method, an ink-jet coating method, a spray coating method, a dip coating method, a gravure coating method, a curtain coating method, and a die coating method.

In the case where the liquid, which is supposed to form the first layer, includes a solvent, it is possible to remove the solvent by applying and then drying the liquid.

The optical member, which can be produced as above, can be stored or used as wound around a roll.

The optical member having the intermediate layer can be produced by a method of forming the first layer or the second layer over the backing film, applying a liquid including a component which forms the intermediate layer over the first or second film by the known method, drying the liquid if necessary, and laminating the first layer or the second layer over the intermediate layer.

The touch panel 100 can be produced by a method that includes, for example, a process of laminating the optical member 1 over one side of the liquid crystal cell 4, a process of laminating the phase difference plate 22 and the polarizer plate 20 over the optical member 1, and a process of providing the polarizer plate 21 and the backlight 60 in this sequence over one side of the liquid crystal cell 4.

In the case where a cover film is present over the optical member 1, the cover film is removed, and the optical member 1 is laminated over the liquid crystal cell 4 with the adhesion layer 31 interposed therebetween, in a direction such that the first layer 11 is located to be adjacent to the liquid cell 4. In the laminating, it is preferred to perform compression using a compression roll.

The compression roll may include a heating means such that it can perform heat compression. In the case of heat compression, the heating temperature is, preferably, from 10 to 100° C., more preferably, from 20 to 80° C. or, even more preferably, from 30 to 60° C. If the heating temperature is below 10° C., the close contact between the optical member 1 and the liquid crystal cell 4 tends to decline. If the heating temperature is above 100° C., the liquid crystal cell 4 tends to deteriorate.

In addition, compression pressure in the heat compression is linear load that is, preferably, from 50 to 1×10⁵ N/m, more preferably, from 2.5×10² to 5×10⁴ N/m or, even more preferably, from 5×10² to 4×10⁴ N/m. If the compression pressure is less than 50 N/m, the close contact between the optical member 1 and the liquid crystal cell 4 tends to decline. If the compression pressure is greater than 1×10⁵ N/m, the possibility that the liquid crystal cell 4 may be destroyed rises. Stacking over this structure is possible.

The phase difference plate 22 and the polarizer plate 20 can also be laminated over the optical member 1 in the same way as above. In addition, it is possible to laminate the polarizer plate 21 opposite the optical member 1 with respect to the liquid crystal cell 4 in the same method.

The method of mounting the backlight 60 on the liquid crystal cell 4 is not specifically limited and a known method can be used. It is possible to use, for example, a method of assembling the liquid crystal cell 4 into a module-forming case or heat-compressing the liquid crystal cell 4 using a sealing material. The backlight 60 includes, for example, an LED, a light guide plate, a reflection plate, and a diffuser plate.

The present invention is not limited to the above-described embodiments, but appropriate alterations are possible without departing from the principle of the invention.

For example, the surface of the second layer adjacent to the first layer may have an irregular shape, and both surfaces of the first layer and/or the second layer may have an irregular shape. However, it is preferred that the surface having an irregular shape be on the opposite side of the first layer and the second layers in order to effectively cause the deformation of the surface. In order to more successfully express the function as a touch panel, it is preferred that the irregular shape is provided to the surface of the first layer 11 adjacent to the second layer 11a, the first layer 11 facing the backlight 60, which serves as a light source.

In addition, the second surface having the flat surface can have rubber elasticity so that the first layer having the irregular shape is made of a hard material that has substantially no rubber elasticity. In this case, when the optical member is pressed, the surface of the second layer is reversibly deformed as it is pushed in by the surface of the first layer having an irregular shape. This deformation can also cause an optical change in the reflected light. If the second layer has rubber elasticity, appropriate conditions thereof, such as compressive elasticity, visible light transmittance, and material, are the same as described for the first layer.

In addition, the display device combined with the optical member of the invention is not limited to an LCD but can be any one that includes a light source and an optical sensor. Examples of the other display device may include a plasma display, an organic electroluminescence display, and electronic paper.

### EXAMPLES

Hereinafter, the present invention will be described more fully with respect to Examples. However, the present invention is not limited to the Examples.

### Example 1

### Manufacturing of First Layer L-1

An irregular surface was formed by performing sand blasting treatment on a polyethylene terephthalate film, and was used as a first layer-forming mold. An additional reactive silicone resin solution (available from Momentive Performance Materials Japan LLC, trade name TSE-3032) was applied uniformly over the irregular surface of the polyethylene terephthalate film using a comma coater. Afterwards, heating was performed for 30 minutes using a hot air convection dryer at 100° C., thereby forming a solid silicone rubber layer, which had one flat surface and the irregular shape on the other surface, as a first layer L-1.

Afterwards, the produced first layer L-1 was peeled from the polyethylene terephthalate, and the maximum height of the irregular shape and the film thickness (i.e., the thickness of the portion except for the irregular shape) were measured using a surface shape-measuring device (Surfcorder-SE-30 D type), available from Kosaka Lab Co., Ltd. As a result, the maximum height was 3 μm, and the film thickness was 100 μm.

Manufacturing of Second Layer L-2

The additional reactive silicone resin solution (available from Momentive Performance Materials Japan LLC, trade name TSE-3032) was applied uniformly over a flat surface of a polyethylene terephthalate film using a comma coater. Afterwards, heating was performed for 30 minutes using a hot air convection dryer at 100° C., thereby forming a solid silicone rubber layer in which both surfaces are flat (second layer L-2).

Afterwards, the produced second layer L-2 was peeled from the polyethylene terephthalate, and the thickness was measured using a surface shape measuring device (Surfcorder-SE-30 D type), available from Kosaka Lab Co., Ltd. The measured thickness was 100 μm.

Manufacturing of Optical Member i

A triacetyl cellulose film having a flat surface was prepared as a backing film. The first layer L-1, produced as above, was laminated over the backing film using a laminator (available from Hitachi Chemical Co., Ltd. under trade name HLM-3000 type). Here, the first layer was laminated in a direction such that the flat surface of the first layer came into contact with the triacetyl cellulose film. The laminating conditions included a roll temperature of 25° C., a substrate transport rate of 1 m/min., and a compression pressure (cylinder pressure) of 4×10⁵ Pa. In the following Examples and Comparative Examples, the laminating, such as laminating of the optical member over the glass substrate, was performed in principle under the same conditions.

Afterwards, the second layer L-2, produced as above, was laminated over the surface of the first layer L-1, which had the irregular shape, using the same apparatus and under the same conditions as in the laminating of the first layer L-1, thereby forming an optical member i over the backing film.

Compressive Elasticity of First Layer L-1 and Second Layer L-2

The additional reactive silicone resin solution, which was used to form the first layer L-1 and the second layer L-2 that constituted the optical member i, was applied uniformly over the flat surface of the polyethylene terephthalate film using a comma coater, and was heated for 30 minutes using a hot air convection dryer at 100° C., thereby forming a solid silicone rubber layer.

Afterwards, a single layer of silicone rubber in which both surfaces were flat was produced by peeling the produced silicone rubber layer from the polyethylene terephthalate film. The thickness of the produced silicone rubber single layer was 100 μm. The produced silicone rubber single layer was laminated over a glass substrate having a thickness of 0.7 mm, thereby producing a sample for evaluating compressive elasticity.

Load and displacement were measured continuously by pressing the sample using a hardness tester (DUH-201 type), available from Shimazu Manufacturing Co., Ltd., specifically, in the direction of thickness of the sample at a temperature of 25° C. under a maximum pressure of 0.1 mN/μm² for 20 seconds by a circular flat depressor having a diameter of φ 50 μm. Compressive elasticity was calculated from the resultant inclination of load to displacement, and was 3 MPa. From this result, it was possible to confirm that the first layer L-1 and the second layer L-2, which formed the optical member i, had rubber elasticity that was able to reversibly deform and restore the surface shape.

Change in Visible Light Transmittance of Optical Member i

The optical member i was laminated over a glass substrate having a thickness of 0.7 mm using the same apparatus and under the same conditions as above. Here, a sample for evaluating a change in visible light transmittance was produced by laminating the optical member in a direction such that the second layer L-2 came into contact with the glass substrate.

The triacetyl cellulose film was peeled from the sample, and a disc-like glass plate having a diameter of φ10 mm and a thickness of 0.7 mm was placed over the second layer L-2. A ray of light in the visible range, produced from a light source of an LED backlight used on an LCD, was emitted onto the sample in a normal line direction, and the luminance a of light, which had passed through the sample in the range of a measurement view angle of 1°, was measured using a luminance colorimeter (BM-5A), available from Topcon Co., Ltd. In addition, only the optical member i was removed from the sample, and in that state, the luminance b of light, which had passed through the glass substrate and the disc-like glass plate, was measured in the same fashion. From the measured luminances a and b, visible light transmittance T1 (=a/b×100(%)), when mechanical pressure was not added to the optical member i, was obtained.

Furthermore, a compressive load of 5×10³ Pa was added between the glass substrate and the disc-like glass plate by placing the disc-like glass plate over the second layer L-2 of the sample in the same fashion as above. In that state, the luminance c of light, which had passed through the sample in the range of a measurement view angle of 1°, was measured in the same fashion as above. In addition, only the optical member i was removed from the sample, and the luminance d of light, which has passed through the glass substrate and the glass plate, was measured in that state. From the measured values of luminance c and d, visible light transmittance T2 (=(c/d)×100(%)), when mechanical pressure was added to the optical member, was obtained. The absolute value of the difference ΔT between the obtained visible light transmittances T1 and T2 was 15%. From this result, it could be confirmed that the visible light transmittance of the produced optical member i was sufficiently changed by the addition of mechanical pressure.

Change in Visible Light Reflectivity of Optical Member i

A glass substrate, which had a thickness of 0.7 mm, and a disc-like glass plate, which had a diameter of φ10 mm and a thickness of 0.7 mm, were placed over a white plate made of magnesium oxide. In addition, visible light was emitted onto the white plate in a normal line direction using a CM512 m3 type spectrophotometer, available from Konica Minolta Holdings Ltd., and the brightness a′ of reflection light, reflected at an angle of 25° with respect to the normal line direction of the white plate, was measured.

Afterwards, the optical member i was laminated over the glass substrate having a thickness of 0.7 mm. Here, the optical member i was laminated in a direction such that the second layer L-2 came into contact with the glass substrate. The triacetyl cellulose film was peeled, and a disc-like glass plate having a diameter of φ10 mm and a thickness of 0.7 mm was placed over the first layer L-1. In that state, in the same fashion as above, visible light was emitted onto the sample in a normal line direction and the brightness b′ of reflection light, reflected at an angle of 25° with respect to the normal line direction of the sample, was measured.

From the measured brightnesses a′ and b′, visible light reflectivity R1 (=b′/a′×100(%)), when mechanical pressure was not added to the optical member i, was obtained.

Furthermore, visible light was emitted onto the sample in a normal line direction in the same fashion as above while a load of 5×10³ Pa was being applied between the glass substrate and the disc-like glass plate. The brightness c′ of light, reflected at an angle of 25° with respect to the normal line direction of the sample, was measured. From the measured brightnesses c′ and a′, the visible light reflectivity R2 (=(c′/a′)×100(%)) of the optical member i, when mechanical pressure was added to the optical member i, was obtained. The absolute value of the difference ΔR between the obtained visible light reflectivities R1 and R2 was 30%. From this result, it could be confirmed that the visible light reflectivity of the produced optical member i was sufficiently changed by the addition of mechanical pressure.

Visible Light Transmittance of Film in which Both Surfaces are Flat and that was Made of the Same Material as First Layer L-1 and Second Layer L-2

The additional reactive silicone resin solution, which was used to form the first layer L-1 and the second layer L-2 that constituted the optical member i, was applied uniformly over the flat surface of the polyethylene terephthalate film using a comma coater, and was heated for 30 minutes using a hot air convection dryer at 100° C., thereby forming a solid silicone rubber layer.

The produced silicone rubber was peeled from the polyethylene terephthalate film, thereby producing a silicone rubber single layer (having a thickness of 20 μm) in which both surfaces were flat for evaluating visible light transmittance. The silicone rubber single layer was laminated over a glass substrate having a thickness of 0.7 mm, thereby manufacturing a sample for evaluating visible light transmittance. A ray of light in the visible range, generated from a light source of an LED backlight, was emitted onto the sample in a normal line direction, and the luminance A of light, which had passed through the sample in the range of a measurement view angle of 1°, was measured using a luminance colorimeter (BM-5 A), available from Topcon Co., Ltd. From this state, only the silicone rubber single layer was removed, and luminance B was measured in the same fashion. From the measured values of luminance A and B, the visible light transmittance T (=A/B×100(%)) of the film in which both surfaces were flat and that was made of the same material as the first layer L-1 and the second layer L-2, was obtained. The result was T=99%, and high transparency could be confirmed.

Difference in Transmittance of Optical Member i According to Incident Direction of Visible Light

The optical member i was laminated over a glass substrate having a thickness of 0.7 mm. Here, the optical member was laminated in a direction such that the second layer L-2 came into contact with the glass substrate. In addition, the triacetyl cellulose film was peeled, thereby manufacturing a sample.

Afterwards, light in the visible range, generated from a light source of an LED backlight, was emitted onto the sample in a normal line direction from the glass substrate, and the luminance A′ of light, which had passed through the sample in the range of a measurement view angle of 1°, was measured using a luminance colorimeter (BM-5 A), available from Topcon Co., Ltd. From this state, only the optical member i was removed, and luminance B′ was measured in the same fashion. From the measured values of luminance A′ and B′, the visible light transmittance T′1 (=A′/B′×100(%)), when visible light was incident from the second layer L-2, was measured.

In the same fashion, a ray of light in the visible range, generated from a light source of an LED backlight, was emitted onto the sample in a normal line direction from the first layer L-1, and the luminance C′ of light, which had passed through the sample in the range of a measurement view angle of 1°, was measured using a luminance colorimeter. From this state, only the optical member i was removed, and luminance D′ was measured in the same fashion. From the measured values of luminance C′ and D′, visible light transmittance T′2 (=(C′/D′)×100(%)), when visible light was incident from the first layer L-1, was measured. The difference ΔT′ between the obtained visible light transmittances T′1 and T′2 was 6%. From this result, it could be confirmed that arrangement of the optical member i over the surface of the display device has characteristics capable of producing good display quality since it is possible to prevent external light from being reflected.

### Example 2

### Manufacturing of Optical Member ii

A triacetyl cellulose film having a flat surface was prepared as a backing film. A mixture of a UV-curing silicone resin solution (available from Momentive Performance Materials Japan LLC under trade name UV-9300) and a photoinitiator (available from Momentive Performance Materials Japan LLC under trade name UV-9380) was applied uniformly over the triacetyl cellulose film using a comma coater. Afterwards, a solid second layer L-3 in which both surfaces were flat was produced by emitting UV rays at an exposure amount of 5×10³ J/m² (a measured amount in i ray (a wavelength of 365 nm)) using a parallel light exposure system (available from ORC Manufacturing Co., Ltd., EXM1201). The thickness of the produced second layer L-3 was measured using a surface shape measuring device (Surfcorder-SE-30 D type), available from Kosaka Lab Ltd., and the measured thickness was 50 μm.

The first layer L-1, produced in Example 1, was laminated over the second layer L-3, thereby producing an optical member ii. Here, the first layer L-1 was laminated in a direction such that the surface of the first layer L-1, which had the irregular shape, came into contact with the second layer L-3.

Change in Visible Light Transmittance of Optical Member ii

In the same fashion as in Example 1, T1 and T2 of the optical member ii were measured, and the difference ΔT was found to be 15%. From this result, it could be confirmed that the visible light transmittance of the optical member ii was sufficiently changed by the addition of mechanical pressure.

Change in Visible Light Reflectivity of Optical Member ii

In the same fashion as in Example 1, R1 and R2 of the optical member ii were measured, and the difference ΔR was found to be 30%.

From this result, it could be confirmed that the visible light reflectivity of the optical member ii was sufficiently changed by the addition of mechanical pressure.

### Example 3

### Manufacturing of Optical Member ii

An irregular surface, formed by performing sand blasting treatment on a polyethylene terephthalate film, was used as a mold for forming a first layer. An additional reactive silicone resin solution (available from Momentive Performance Materials Japan LLC under trade name TSE-3450) was applied uniformly over the irregular surface of the polyethylene terephthalate film using a comma coater. Afterwards, heating for 30 minutes was performed using a hot air convection dryer at 100° C., thereby forming a solid silicone rubber layer, which had one flat surface and the irregular shape on the opposing surface, as a first layer L-4. The maximum height and film thickness of the produced first layer L-4 were measured in the same fashion as in Example 1. The maximum height was 6 μm, and the film thickness was 100 μm.

A triacetyl cellulose film, in which both surfaces were flat and with a film thickness of 50 μm, was prepared and used as a second layer L-5. An optical member iii was produced by laminating the first layer L-4 over the second layer L-5. Here, the first layer L-4 was laminated in a direction such that the surface of the first layer L-4, which had the irregular shape, came into contact with the second layer L-5.

Compressive Elasticity of First Layer L-4

The additional reactive silicone resin solution, which was used to form the first layer L-4, was applied uniformly over the flat surface of the polyethylene terephthalate film using a comma coater, and heated for 30 minutes using a hot air convection dryer at 100° C., thereby forming a solid silicone rubber layer. The compressive elasticity of the produced silicone rubber layer was measured in the same fashion as in the first layer L-1 and the second layer L-2, and the measured compressive elasticity was 5 MPa. From this result, it could be confirmed that the first layer L-4, which constituted the optical member iii, had rubber elasticity that was able to reversibly deform and restore the surface.

Change in Visible Light Transmittance of Optical Member iii

T1 and T2 of the optical member iii were measured in the same fashion as in Example 1, and the difference ΔT was found to be 20%. From this result, it could be confirmed that the visible light transmittance of the optical member iii was sufficiently changed by the addition of mechanical pressure.

Change in Visible Light Reflectivity of Optical Member iii

In the same fashion as in Example 1, R1 and R2 of the optical member iii were measured, and the difference ΔR was found to be 35%. From this result, it could be confirmed that the visible light reflectivity of the optical member iii was sufficiently changed by the addition of mechanical pressure.

Visible Light Transmittance of Film in which Both Surfaces Are Flat and that is Made of the Same Material as First Layer L-4

The additional reactive silicone resin solution, which was used to form the first layer L-4 that constituted the optical member i, was applied uniformly over the flat surface of the polyethylene terephthalate film using a comma coater, and heated for 30 minutes using a hot air convection dryer at 100° C., thereby forming a solid silicone rubber layer.

A silicone rubber single layer (having a thickness of 20 μm) in which both surfaces were flat, for evaluating visible light transmittance, was produced by peeling the produced silicone rubber layer from the polyethylene terephthalate film. A sample for evaluating visible light transmittance was manufactured by laminating the silicone rubber single layer over a glass substrate having a thickness of 0.7 mm. A ray of light in the visible range, generated from a light source of an LED backlight used on an LCD, was emitted onto the sample in a normal line direction, and the luminance A of light, which had passed through the sample in the range of a measurement view angle of 1°, was measured using a luminance colorimeter (BM-5 A), available from Topcon Co., Ltd. From this state, only the silicone rubber single layer was removed, and luminance B was measured in the same fashion. From the measured values of luminance A and B, the visible light transmittance T (=A/B×100(%)) of the layer, in which both surfaces were flat and that was made of the same material as the first layer L-4, was obtained. The result was T=99%, and high transparency could be confirmed.

### Example 4

### Manufacturing of Optical Member iv

A photosensitive resin solution was prepared by dissolving a photosensitive resin having the following composition into propylene glycol monoethyl ether acetate.

Composition of the Photosensitive Resin:

a copolymer resin (average molecular weight 60000 (a standard polystyrene-converted value in measurement according to the gel permeation chromatography method)) of acrylic acid/butyl acrylate/vinyl acetate=15/30/55 (part by weight) 33% by weight butyl acrylate 53% by weight vinyl acetate 8% by weight acrylic acid 2% by weight hexanediol acrylate 1% by weight benzoin isobutyl ether 3% by weight

The photosensitive resin solution was applied uniformly over a polyethylene terephthalate film having a thickness of 50 μm using a comma coater. Afterwards, drying was performed for 5 minutes using a hot air convection dryer at 100° C., thereby forming a photosensitive layer made of a photosensitive resin.

Afterwards, the photosensitive resin was photo-cured by emitting UV rays onto it at an exposure amount of 5×10³ J/m² (a measured amount in i ray (a wavelength of 365 nm)) while pressing a roll-like disc having an irregular pattern against it. Afterwards, the roll-like disc was removed, thereby forming an irregular shape on the surface of the photosensitive layer. The photosensitive layer having the irregular surface was used as a mold for forming a first layer L-6.

An additional reactive silicone resin solution (available from Momentive Performance Materials Japan LLC, trade name TSE-3032) was applied uniformly over the irregular surface of the photosensitive layer using a comma coater. In succession, heating was performed for 30 minutes, using a hot air convection dryer at 100° C., thereby forming a solid silicone rubber layer (the first layer L-6) that had one flat surface and the irregular shape on the other surface.

The produced first layer L-6 was removed from the photosensitive layer, and the maximum height of the irregular surface and the film thickness (i.e., the thickness of the portion of the surface except for the irregular surface) were measured in the same fashion as in Example 1. The maximum height was 5 μm, and the film thickness was 100 μm.

Afterwards, the first layer L-6 was laminated over the flat surface of the second layer L-5, the same as that in Example 3, thereby producing an optical member iv. Here, the first layer L-6 was laminated in a direction such that the irregular surface of the first layer L-6 came into contact with the second layer L-5.

Compressive Elasticity of First Layer L-6

The additional reactive silicone resin solution, which was used to form the first layer L-6, was applied uniformly over the flat surface of the polyethylene terephthalate film using a comma coater, and was heated for 30 minutes using a hot air convection dryer at 100° C., thereby forming a solid silicone rubber layer. The compressive elasticity of the produced silicone rubber layer was measured in the same fashion as in the first layer L-1 and the second layer L-2, and the measured compressive elasticity was 3 MPa. From this result, it could be confirmed that the first layer L-6, which constituted the optical member iv, had rubber elasticity that was able to reversibly deform and restore the surface shape.

Change in Visible Light Transmittance of Optical Member iv

In the same fashion as in Example 1, T1 and T2 of the optical member iv were measured, and the difference ΔT was found to be 18%. From this result, it could be confirmed that the visible light transmittance of the produced optical member iv was sufficiently changed by the addition of mechanical pressure.

Change in Visible Light Reflectivity of Optical Member iv

In the same fashion as in Example 1, R1 and R2 of the optical member iv were measured, and the difference ΔR was found to be 38%. From this result, it could be confirmed that the visible light reflectivity of the produced optical member iv was sufficiently changed by the addition of mechanical pressure.

Visible Light Transmittance of Film in which Both Surfaces Are Flat and that is Made of the Same Material as First Layer L-6

The additional reactive silicone resin solution, which was used to form the first layer L-6, was applied uniformly over the flat surface of the polyethylene terephthalate film using a comma coater, and heated for 30 minutes using a hot air convection dryer at 100° C., thereby forming a solid silicone rubber layer.

The produced silicone rubber layer was peeled from the polyethylene terephthalate film, thereby producing a silicone rubber single layer (having a thickness of 20 μm) in which both surfaces were flat for evaluating visible light transmittance. The silicone rubber single layer was laminated over a glass substrate having a thickness of 0.7 mm using the same apparatus and under the same conditions, thereby manufacturing a sample for evaluating visible light transmittance. A ray of light in the visible range, produced from a light source of an LED backlight used on an LCD, was emitted onto the sample in a normal line direction, and the luminance A of light, which had passed through the sample in the range of a measurement view angle of 1°, was measured using a luminance colorimeter (BM-5A), available from Topcon Co., Ltd. From this state, only the silicone rubber single layer was removed, and luminance B was measured in the same fashion. From the measured luminances A and B, the visible light transmittance T (=A/B×100(%)) of the film having the flat both surfaces, made of the same material as the first layer L-6, was measured. The result was T=99%, and high transparency could be confirmed.

### Example 5

Manufacturing of First Layer L-7

The photosensitive resin solution, the same as that in Example 4, was applied uniformly over a triacetyl cellulose film having a thickness of 50 μm using a comma coater. Afterwards, heating was performed for 5 minutes using a hot air convection dryer at 100° C., thereby forming a photosensitive layer made of the photosensitive resin.

Afterwards, the photosensitive resin was photo-cured by emitting UV rays at an exposure amount of 5×10³ J/m² (a measured amount in i ray (a wavelength of 365 nm)) while pressing a roll-like disc having an irregular pattern against it. Afterwards, the roll-like disc was removed, thereby forming an irregular shape on the surface of the photosensitive layer. The photosensitive layer having the irregular surface was used as a first layer L-7.

The maximum height of the irregular surface and the film thickness (i.e., the thickness of the portion except for the irregular surface) of the first layer L-7 were measured in the same fashion as in Example 1. The maximum height was 4 μm, and the film thickness was 100 μm.

Manufacturing of Second Layer L-8

An additional reactive silicone resin solution (available from Momentive Performance Materials Japan LLC, trade name TSE-3032) was applied uniformly over the flat surface of the triacetyl cellulose film serving as a backing film using a comma coater. Afterwards, heating was performed for 30 minutes using a hot air convection dryer at 100° C., thereby forming a solid silicone rubber layer (second layer L-8) in which both surfaces were flat. The thickness of the produced second layer L-8 was measured using a surface shape measuring device (Surfcorder-SE-30 D type), available from Kosaka Lab Ltd., and the measured thickness was 50 μm.

Manufacturing of Optical Member v

The second layer L-8 was tacked over the surface of the first layer L-7, which had the irregular shape, thereby producing an optical member v. Here, the second layer L-8 was laminated in a direction such that the second layer L-8 came into contact with the flat surface of the first layer L-7, which had the irregular shape.

Compressive Elasticity of Second Layer L-8

The additional reactive silicone resin solution, which was used to form the second layer L-8, was applied uniformly over the flat surface of the polyethylene terephthalate film using a comma coater, and was heated for 30 minutes using a hot air convection dryer at 100° C., thereby forming a solid silicone rubber layer (having a thickness of 100 μm). The compressive elasticity of the produced silicone rubber layer was measured in the same fashion as in the first layer L-1 and the second layer L-2, and the measured compressive elasticity was 3 MPa. From this result, it could be confirmed that the second layer L-8, which constituted the optical member v, had rubber elasticity that was able to reversibly deform and restore the surface shape.

Change in Visible Light Transmittance of Optical Member v

In the same fashion as in Example 1, T1 and T2 of the optical member v were measured, and the difference ΔT was found to be 17%. From this result, it could be confirmed that the visible light transmittance of the produced optical member v was sufficiently changed by the addition of mechanical pressure.

Change in Visible Light Reflectivity of Optical Member v

In the same fashion as in Example 1, R1 and R2 of the optical member v were measured, and the difference ΔR was found to be 37%. From this result, it could be confirmed that the visible light reflectivity of the produced optical member v was sufficiently changed by the addition of mechanical pressure.

Visible Light Transmittance of Film in which Both Surfaces Are Flat and that is Made of the Same Material as the Second Layer L-8

The additional reactive silicone resin solution, which was used to form the second layer L-8, was applied uniformly over the flat surface of the polyethylene terephthalate film using a comma coater, and was heated for 30 minutes using a hot air convection dryer at 100° C., thereby forming a solid silicone rubber layer.

The produced silicone rubber layer was removed from the polyethylene terephthalate film, thereby producing a silicone rubber single layer (having a thickness of 20 μm) in which both surfaces were flat for evaluating visible light transmittance. The silicone rubber single layer was laminated over a glass substrate having a thickness of 0.7 mm using the same apparatus and under the conditions as above, thereby manufacturing a sample for evaluating visible light transmittance. A ray of light in the visible range, produced from a light source of an LED backlight used on an LCD, was emitted onto the sample in a normal line direction, and the luminance A of light, which had passed through the sample in the range of a measurement view angle of 1°, was measured using a luminance colorimeter (BM-5A), available from Topcon Co., Ltd. In this state, only the silicone rubber single layer was removed, and luminance B was measured in the same fashion. From the measured values of luminance A and B, the visible light transmittance T (=A/B×100(%)) of the film in which both surfaces were flat, made of the same material as the second layer L-8, was obtained. The result was T=99%, and high transparency could be confirmed.

### Example 6

### Manufacturing of Optical Member vi

A resin solution was prepared by dissolving a laminating resin having the following composition into propylene glycol monoethyl ether acetate.

Composition of the Laminating Resin:

a copolymer resin (average molecular weight 30000 (a standard polystyrene-converted value in measurement according to the gel permeation chromatography method)) of methacrylic acid/methacrylic acid benzyl=15/85 (part by weight) 30% by weight

o-phenyl phenol glycydyl ether acrylate 70% by weight

The resin solution was applied uniformly over the flat surface of the second layer L-5, the same as that in Example 3, using a comma coater, and drying was performed for 5 minutes using a hot air convection dryer at 100° C., thereby forming an intermediate layer that was an laminating resin layer. The first layer L-4, the same as that in Example 3, was laminated over the second layer L-5 with the intermediate layer interposed therebetween, thereby producing an optical member vi. Here, the first layer L-4 was laminated in a direction such that the surface of the first layer L-4, which had the irregular shape, came into contact with the intermediate layer.

Change in Visible Light Transmittance of Optical Member vi

In the same fashion as in Example 1, T1 and T2 of the optical member vi were measured, and the difference ΔT was found to be 12%. From this result, it could be confirmed that the visible light transmittance of the produced optical member vi was sufficiently changed by the addition of mechanical pressure.

Change in Visible Light Reflectivity of Optical Member vi

In the same fashion as in Example 1, R1 and R2 of the optical member vi were measured, and the difference ΔR was found to be 27%. From this result, it could be confirmed that the visible light reflectivity of the produced optical member vi was sufficiently changed by the addition of mechanical pressure.

Refractive Index

The additional reactive silicone resin solution, which was used to form the first layer L-4, was diluted by methyl ethyl ketone and applied uniformly over a silicon wafer using a spin coater. Afterwards, heating was performed for 30 minutes using a hot air convection dryer at 100° C., thereby forming a silicone rubber layer (having a thickness of 2 μm). The refractive index of this silicone rubber layer was measured using a refractometer (2010 type prism coupler, light source: laser, wavelength: 633 nm), available from Metricon Company, and the measured refractive index was n1=1.41.

In order to form the intermediate layer, a resin having the above-described adhesion was dissolved into methyl ethyl ketone, and the resultant solution was applied uniformly over a silicon wafer using a spin coater. Afterwards, heating was performed for 30 minutes using a hot air convection dryer at 100° C., thereby forming an laminating resin layer (having a thickness of 2 μm). The refractive index of this resin layer was measured using the same apparatus as above, and the measured refractive index was n2=1.56.

The difference Δn between the refractive index n1 of the silicone rubber, which formed the first layer L-4, and the refractive index n2 of the laminating resin, which formed the intermediate layer, was 0.15. From this result, it was confirmed that the optical member vi had a function of reflecting or scattering incident visible light when mechanical pressure was not added, and the visible light transmittance of the optical member was sufficiently changed when mechanical pressure was added.

### Comparative Example 1

### Manufacturing of Comparative Optical Member

A polyethylene terephthalate film, in which both surfaces were flat and that had a film thickness of 100 μm, was prepared as a first layer r-1. A photosensitive resin solution, produced by dissolving a photosensitive resin having the following composition into propylene glycol monoethyl ether acetate, was applied uniformly over the first layer r-1 using a comma coater, and drying was performed for 5 minutes using a hot air convection dryer at 100° C., thereby forming a photosensitive layer.

Composition of Photosensitive Resin:

Methacrylic acid/methacrylic acid benzyl/methacrylic acid methyl copolymer resin 55% by weight

Dipentaerythritol hexa acrylate 40% by weight

Benzophenone 4.7% by weight

N,N′-tetra ethyl-4,4′-diaminobenzophenone 0.3% by weight

A second layer r-2 in which both surfaces were flat was produced by emitting UV rays at an exposure amount of 5×10³ J/m² (a measured amount in i ray (a wavelength of 365 nm)) using a parallel light exposure system (available from ORC Manufacturing Co., Ltd., EXM1201). From this, a comparative optical member, made of the same material as the first layer r-1 and the second layer r-2, was obtained. The thickness of the produced second layer r-2 was measured using a surface shape measuring device (Surfcorder-SE-30 D type), available from Kosaka Lab Ltd., and the measured thickness was 50 μm.

Compressive Elasticity of First Layer r-1 and Second Layer r-2

The compressive elasticity of the polyethylene terephthalate film, which was used as the first layer r-1, was measured in the same fashion as in Example 1, and the measured compressive elasticity was 50 GPa. It was confirmed that the polyethylene terephthalate film had substantially no rubber elasticity since it was plastically deformed when significantly bent.

In addition, the photosensitive resin solution, which was used to form the second layer r-2, was applied uniformly over the flat surface of the polyethylene terephthalate film having a film thickness of 50 μm using a comma coater, and drying was performed for 5 minutes using a hot air convection dryer at 100° C., thereby forming a photosensitive layer. Afterwards, UV rays were emitted at an exposure amount of 5×10³ J/m² (a measured amount in i ray (a wavelength of 365 nm)) from the polyethylene terephthalate film and the photosensitive resin composition layer, respectively, using a parallel light exposure system (available from ORC Manufacturing Co., Ltd., EXM1201). This formed a photosensitive layer having a film thickness of 100 μm, made of the same material as the second layer r-2, the photosensitive layer for evaluating compressive elasticity. The compressive elasticity of the produced photosensitive layer was measured in the same fashion as in Example 1, and the measured compressive elasticity was 70 GPa. In addition, the photosensitive layer had substantially no rubber elasticity since it was plastically deformed when significantly bent.

Change in Visible Light Transmittance of Comparative Optical Member

T1 and T2 of the comparative optical member were measured in the same fashion as in Example 1, and the difference ΔT was found to be 0.04%.

Change in Visible Light Reflectivity of Comparative Optical Member

R1 and R2 of the comparative optical member were measured in the same fashion as in Example 1, and the difference ΔR was found to be 0.05%.

The constructions of the optical members, manufactured as above, and the evaluation results thereof are listed in Table 1.

TABLE 1

| | | | | Internal | Compression | | |
|---|---|---|---|---|---|---|---|
| | | | | surface | modulus | | Rubber |
| Optical | | | | (max. | of | Film | elasticity |
| member | Laminated structure | | | height) | elasticity | thickness | (Y/N) |
| (i) | First | L-1 | Silicone | Irregular | 3 MPa | 100 μm | Y |
| | layer | | rubber | (3 μm) | | | |
| | Second | L-2 | Silicone | Flat | 3 MPa | 100 μm | Y |
| | layer | | rubber | | | | |
| (ii) | First | L-1 | Silicone | Irregular | 3 MPa | 100 μm | Y |
| | layer | | rubber | (3 μm) | | | |
| | Second | L-3 | UV-hardened | Flat | — | 50 μm | |
| | layer | | silicone resin | | | | |
| (iii) | First | L-4 | Silicone | Irregular | 5 MPa | 100 μm | Y |
| | layer | | rubber | (6 μm) | | | |
| | Second | L-5 | Triacetyl | Flat | — | 50 μm | |
| | layer | | cellulose | | | | |
| (iv) | First | L-6 | Silicone | Irregular | 3 MPa | 100 μm | Y |
| | layer | | rubber | (5 μm) | | | |
| | Second | L-5 | Triacetyl | Flat | — | 50 μm | |
| | layer | | cellulose | | | | |
| (v) | First | L-7 | Photosensitive | Irregular | — | 100 μm | |
| | layer | | resin | (4 μm) | | | |
| | Second | L-8 | Silicone | Flat | 3 MPa | 50 μm | Y |
| | layer | | rubber | | | | |
| (vi) | First | L-6 | Silicone | Irregular | 3 MPa | 100 μm | Y |
| | layer | | rubber | (5 μm) | | | |
| | Intermediate | | Adhesive | — | — | — | |
| | layer | | resin | | | | |
| | Second | L-5 | Triacetyl | Flat | — | 50 μm | |
| | layer | | cellulose | | | | |
| Comparison | First | r-1 | Polyethylene | Flat | 50 GPa | 100 μm | N |
| | layer | | terephalate | | | | |
| | Second | r-2 | Photosensitive | Flat | 70 GPa | 50 μm | N |
| | layer | | resin | | | | |

TABLE 2

| | Difference in | Difference in |
|---|---|---|
| Optical | visible light | visible light |
| member | transmission | reflectivity |
| (i) | 15% | 30% |
| (ii) | 15% | 30% |
| (iii) | 20% | 35% |
| (iv) | 18% | 38% |
| (v) | 17% | 37% |
| (vi) | 12% | 27% |
| Comparison | 0.04% | 0.05% |

### Examination of Touch Panel Function

### Example 7

An evaluating liquid crystal cell was prepared by arranging both substrates to be opposite each other and sealing liquid crystal between the both substrates. One substrate had a Thin Film Transistor (TFT), an optical sensor, a light-shielding film, electrical lines, an insulating film, an alignment film, an electrode, and the like mounted thereon. The other substrate had a color filter, a black matrix, a planarizing film, a transparent electrode, an alignment film, a sealing material, and a spacer material mounted thereon. An optical member i was laminated over the evaluating liquid crystal cell using a laminator (available from Hitachi Chemical Co., Ltd. under trade name HLM-3000 type). Here, the first layer L-1 was laminated in such a fashion that the flat surface of the first layer L-1 came into contact with the substrate on which the color filter of the evaluating liquid crystal cell was formed. In this case, the laminating conditions were a roll temperature of 25° C., a substrate transport rate of 1 m/min, and a compression pressure (i.e., a cylinder pressure) of 1×10⁵ Pa.

In the same laminating method as above, a phase difference plate and a polarizer plate were laminated sequentially over the second layer L-2 of the optical member i laminated over the evaluating liquid crystal cell. In addition, in the same laminating method as above, a polarizer plate was laminated over the surface opposite the optical member i of the evaluating liquid crystal cell. In addition, a backlight device having an LED was provided to be opposite the optical member i, thereby manufacturing a liquid crystal module for evaluating a touch panel function.

The liquid crystal module was connected to a drive circuit and was driven by a program that executes the touch panel function. In addition, in a dark place, the liquid crystal screen was touched using a pen made of an insulator, from the optical member i. Positions touched by the pen were detected by the optical sensor, and an image could be obtained as programmed without errors. From this result, it could be confirmed that the touch panel function operated without a problem when the optical member i was mounted. In addition, display quality was good since external light was prevented from being reflected.

### Comparative Example 2

An evaluating liquid crystal module for evaluating a touch panel function was manufactured in the same fashion as in Example 7, except that the comparative optical member, produced in Comparative Example 1, was used instead of the optical member i.

The produced liquid crystal module was connected to a drive circuit and was driven by a program that executes the touch panel function, and in a dark location, the liquid crystal screen was touched using a pen made of an insulator. However, positions touched by the pen were not detected, and a change in an image was not observed. That is, it was impossible to normally operate the liquid crystal module as a touch panel.

1. An optical member for a touch panel having a pair of opposite main surfaces, wherein:
a reflection state of light being incident from one of the main surfaces is changed when the optical member is pressed from another one of the main surfaces.

2. An optical member for a touch panel having a pair of opposite main surfaces, comprising:
a first layer and a second layer laminated over the first layer, a surface of the first layer adjacent to the second layer having an irregular shape, and
the surface of the first layer and a surface of the second layer being partially or completely separated from each other; and
the surface of the first layer and/or the surface of the second layer being reversibly deformed, thereby changing a reflection state of light being incident from one of the main surfaces when the optical member is pressed from another one of the main surfaces.

3. The optical member for a touch panel according to claim 2, wherein the first layer and/or the second layer has rubber elasticity.

4. The optical member for a touch panel according to claim 2, wherein the irregular shape has a maximum height of from 0.01 to 50 μm.

5. The optical member for a touch panel according to claim 2, wherein an intermediate layer is provided between the first layer and the second layer, the intermediate layer having a refractive index different from that of the first layer.

6. The optical member for a touch panel according to claim 5, wherein the intermediate layer is laminating.

7. A laminated body comprising a backing film and an optical member laminated over the backing film, the optical member being described in claim 1.

8. A manufacturing method for the optical member described in claim 2, the method comprising:
forming a first layer on an irregular surface of a mold, the first layer having a surface with an irregular shape transferred from the irregular surface;
peeling the first layer from the mold; and
laminating a second layer over the surface of the peeled first layer having the irregular shape.

9. A manufacturing method for the optical member described in claim 3, the method comprising:
forming a first layer on an irregular surface of a mold, the first layer having a surface with an irregular shape transferred from the irregular surface;
peeling the first layer from the mold; and
laminating a second layer over the surface of the peeled first layer having the irregular shape.

10. A manufacturing method for the optical member described in claim 4, the method comprising:
forming a first layer on an irregular surface of a mold, the first layer having a surface with an irregular shape transferred from the irregular surface;
peeling the first layer from the mold; and
laminating a second layer over the surface of the peeled first layer having the irregular shape.

11. A manufacturing method for the optical member described in claim 5, the method comprising:
forming a first layer on an irregular surface of a mold, the first layer having a surface with an irregular shape transferred from the irregular surface;
peeling the first layer from the mold; and
laminating a second layer over the surface of the peeled first layer having the irregular shape.

12. A manufacturing method for the optical member described in claim 6, the method comprising:
forming a first layer on an irregular surface of a mold, the first layer having a surface with an irregular shape transferred from the irregular surface;
peeling the first layer from the mold; and
laminating a second layer over the surface of the peeled first layer having the irregular shape.

13. A laminated body comprising a backing film and an optical member laminated over the backing film, the optical member being described in claim 2.

14. A laminated body comprising a backing film and an optical member laminated over the backing film, the optical member being described in claim 3.

15. A laminated body comprising a backing film and an optical member laminated over the backing film, the optical member being described in claim 4.

16. A laminated body comprising a backing film and an optical member laminated over the backing film, the optical member being described in claim 5.

17. A laminated body comprising a backing film and an optical member laminated over the backing film, the optical member being described in claim 6.
